(19) United States
(12) Patent Application Publication
(10) Pub. No.: US 2024/0125695 A1
(43) Pub. Date: Apr. 18, 2024

(54) OPTICAL ANALYSIS SYSTEM FOR ANALYSING BIOLOGICAL PROCESSES

(71) Applicant: TTP Plc., Royston, Hertfordshire (GB)

(72) Inventors: Alexander Roy CARR, Royston, Hertfordshire (GB); Stephen Russell TAYLOR, Royston, Hertfordshire (GB); Wenshu XU, Royston, Hertfordshire (GB); Alexander CONEY, Royston, Hertfordshire (GB); Donal PRICE, Royston, Hertfordshire (GB); Andrew MALLOY, Royston, Hertfordshire (GB); William Joseph HAML YN, Royston, Hertfordshire (GB)

(21) Appl. No.: 18/277,544

(22) PCT Filed: Feb. 17, 2022
(86) PCT No.: PCT/GB2022/050436

§ 371 Date: Aug. 16, 2023

(30) Foreign Application Priority Data
Feb. 17, 2021 (GB) 2102260.3

(51) Int. Cl. G01N 21/3577

(52) U.S. Cl. CPC G01N 21/3577

(57) ABSTRACT

An optical system (31) for analysing biological processes comprising: a biological process vessel (33) comprising a chamber and an optical interface element (34) for optically coupling the chamber to an optical emitter, a wavelength discrimination component, and an optical detector when a biological process fluid in the chamber is being analysed, the optical interface element being configured to couple light in the mid-infrared range; an optical emitter (351) configured to emit light in the mid-infrared range; an optical detector (353) configured to detect light in the mid-infrared range; a wavelength discrimination component (352); an alignment component (42) for aligning the optical emitter, optical detector, and wavelength discrimination component with the optical interface element; and a processor (354) configured to: receive outputs from the optical detector; and process the received outputs from the optical detector to provide an indication of the constituents of a biological process fluid in the chamber.

### RELATED APPLICATION

The present application is a national stage application under 35 U.S.C. § 371 of International Application No. PCT/GB2022/050436, filed Feb. 17, 2022, which claims priority to Great Britain Patent Application No. 2102260.3, filed Feb. 17, 2021. The above referenced applications are hereby incorporated by reference.

### FIELD OF INVENTION

The present invention relates to an optical analysis system for analysing biological processes and a biological process vessel.

### BACKGROUND OF INVENTION

During biological processing, there is a need to ensure that batches of biological process fluids are progressing as expected in order to highlight unexpected developments. This need is especially acute in process development scale (PD scale) bioreactors as the process conditions for a specific biological process fluid are developed and optimized.

In order to address this need, biological process fluids are monitored during processing. A typical way to carry out this monitoring involves analysing the absorption spectrum of a solution to determine the concentration of specific analytes within that solution. This technique is based on the fact that each analyte has a characteristic absorption spectrum, which can then be identified in the absorption spectrum of the solution.

The analytes of interest in biological processing typically have a characteristic absorption spectrum in the mid-infrared spectrum, defined as radiation having a wavenumber in the range of around 500 cm-1 to around 4000 cm-1, and mid-infrared absorption in particular is a well-established technique to monitor the concentration of specific analytes within solution. However, current systems are expensive and require an off-line measurement, which is to say that it is necessary to take a sample of a biological process fluid for analysis. This often involves manual intervention which threatens the sterility of the closed vessel containing the biological process fluid. It can therefore be seen that there is a conflict between the need to monitor biological process fluids during processing and the need to avoid contamination of those biological process fluids.

Currently, there are no practical solutions available on the market that are capable of being integrated directly into individual process vessels in a cost-effective manner, to provide on-line measurements (i.e. measurements that do not require a sample of the biological process fluid to be taken for analysis). Previous attempts to integrate mid-infrared spectroscopy into process vessels have required large and expensive benchtop equipment to be modified to interface with generic ports in process vessels. These approaches also require a significant amount of time and skill to set-up. Consequently, current solutions for monitoring biological processes are unfeasible for large-scale use.

There is therefore a need to enable continuous on-line monitoring of the concentration of key compounds within a biological process fluid in order to provide better real-time control of biological processing.

### SUMMARY OF INVENTION

In a first aspect of the invention, an optical system for analysing biological processes is provided, the optical system comprising: a biological process vessel comprising a chamber and an optical interface element for optically coupling the chamber to an optical emitter, a wavelength discrimination component, and an optical detector when a biological process fluid in the chamber is being analysed, the optical interface element being configured to couple light in the mid-infrared range; an optical emitter configured to emit light in the mid-infrared range; an optical detector configured to detect light in the mid-infrared range; a wavelength discrimination component; an alignment component for aligning the optical emitter, optical detector, and wavelength discrimination component with the optical interface element; and a processor configured to: receive outputs from the optical detector; and process the received outputs from the optical detector to provide an indication of the constituents of a biological process fluid in the chamber.

By incorporating an optical interface element into a biological process vessel, it is possible to take non-invasive measurements of the absorption spectrum of a biological process fluid in the biological process vessel. Current approaches to determining the concentration of analytes in a biological process fluid involve taking samples and may involve the addition of additives, such as enzymes or dyes, to the biological process fluid or sample thereof which may not be compatible with the biological process. In contrast, systems provided according to the first aspect allow measurements to be taken in-situ without the use of additives. This ensures the biological process fluid is not disturbed or otherwise contaminated. This approach is also less time consuming than approaches involving the collection of samples for analysis. It should be also be emphasised that the indication of the constituents of a biological process fluid in the chamber includes an indication of the concentration of those constituents in the biological process fluid. For example, the indication could include the concentration of compounds such as glucose and lactate as well as the concentration of one or more amino acids in the biological process fluid.

Furthermore, by making use of an optical emitter, a wavelength discrimination component, and an optical detector that can be detached from an optical interface element integral to the process vessel, the system of the first aspect of the invention enables the use of a single-use process vessel. This is particularly advantageous as the optical hardware components (which in the first aspect of the invention include the optical emitter, wavelength discrimination component, and optical detector) are typically the most expensive components in biological analysis systems.

In a system in which the optical hardware is integral to the biological process vessel it is necessary either to design the biological process vessel to be reusable, which is typically undesirable and impractical, or to dispose of the optical hardware along with the biological process vessel. This is costly and wasteful, and in most cases would also mean using cheaper optical hardware, which would lead to a lower quality of measurements being taken of the biological process fluid being analysed. By enabling the use of a single-use process vessel that can be detached from reusable optical hardware, these problems are overcome.

The processor is not limited to being a microprocessor and could, for example, be an electronic circuit comprising an op-amp, transistors, or other electronic components configured to process the analogue signals needed to receive signals from the optical detector. It could also be a computer system. In addition to receiving and processing the outputs from the optical detector, it could also be configured to control the analysis of the biological process fluid. For example, the processor could be configured to control operation of the optical emitter.

By ensuring the optical interface element is properly aligned with the optical emitter, optical detector, and wavelength discrimination component, the alignment component ensures the outputs of from the optical detector can be adequately processed to provide an indication of the constituents of the biological process fluid. In support of this, the alignment component could comprise one or more engagement elements for engaging the optical emitter, optical detector, and optical filter wavelength discrimination component with the optical interface element. The biological process could likewise comprise one or more engagement elements for engaging the biological process vessel with the optical emitter, optical detector, and wavelength discrimination component. The engagement components could comprise bayonet fittings or magnetic attachments, or could comprise one or more guide pins provided on either the alignment component or the biological process vessel which are received by a corresponding one or more holes on the other of the alignment component and the biological process vessel.

In order to ensure accurate measurements in the wavenumber range of interest, the optical interface element is configured to couple light in the mid-infrared range, which is to say that it is substantially transparent to light in the range of 500 cm⁻¹ to 4000 cm⁻¹. Suitable materials for this purpose are Zinc Selenide (ZnSe), Germanium (Ge), and diamond.

The chamber may be configured to hold the bulk biological process fluid but may also comprise one of a culture vessel, fluid well, flow cell, capillary tube, flow path, or bypass loop.

The optical interface element is preferably in direct contact with a biological process fluid in the chamber when said biological process fluid is being analysed, and in many embodiments of the first aspect at least two faces of the surface of the optical interface element are in direct contact with said biological process fluid when said biological process fluid is being analysed.

It has been found that embodiments of the first aspect of the invention are particularly suited to applications in which the optical interface element is an optical attenuated total reflection interface element, as this eliminates the potential for the narrow channels required for transmission-based measurements to become blocked.

In order to ensure efficient coupling between the optical attenuated total reflection interface element of the biological process vessel and emitter-receiver hardware over a range of positions of said emitter-receiver hardware relative to the optical attenuated total reflection interface element, the attenuated total reflection optical interface element may take a number of forms different from a prism, which is typically the shape of standard attenuated total reflection optical interface elements. For example, the attenuated total reflection optical interface element may take the form of a lens or may comprise an optical fibre.

In preferred embodiments of the first aspect of the invention, the biological process vessel is reversibly removable from the system. By including the source, filter, and detector separately from the reversibly removable biological process vessel, a single use optical interface element can be incorporated into the biological process vessel, allowing for a single-use biological process vessel to be used.

Standard multi-use devices require cleaning between uses, representing a significant sterility risk in addition to being time intensive. A single-use biological process vessel overcomes these drawbacks and therefore provides a cost-effective and sterile solution.

Furthermore, this improves the compatibility of the system with standard sterilization methods. Single-use process vessels are typically sterilized by gamma radiation or ethylene oxide (ETO), which are known to interact with some common materials employed in optical components due to their relative transparency to mid-infrared radiation. The reversibly removable biological process vessel can be sterilized separately from the other elements of the system, which means that a wider selection of materials can be chosen for use with the other aspects of the system, such as the emitter, filter, and detector.

In embodiments in which the biological process vessel is reversibly removable from the system, the optical emitter, optical detector, and wavelength discrimination component (or plurality of wavelength discrimination components, as discussed below) are typically comprised in an emitter-receiver hardware device, which allows for convenient measurements to be taken across multiple biological process vessels.

Systems provided according to the first aspect are typically used for taking infrared absorption spectrum measurements, and as such the optical emitter is typically configured to emit infrared radiation in the wavenumber range of 500 cm⁻¹ to 4000 cm⁻¹, in some embodiments specifically in the range of 500 cm⁻¹ to 1500 cm⁻¹, and in still further embodiments specifically in the range of 900 cm⁻¹ to 1500 cm⁻¹.

Likewise, the optical detector is typically configured to detect infrared radiation in the wavenumber range of 500 cm⁻¹ to 4000 cm⁻¹, and in some embodiments specifically in the range of 500 cm⁻¹ to 1500 cm⁻¹. Still further embodiments are configured to detect radiation specifically in the range of 900 cm⁻¹ to 1500 cm⁻¹.

The wavelength discrimination component is typically positioned between the optical detector and the optical interface element when the biological process fluid in the chamber is being analysed, although the wavelength discrimination component could also be positioned between the optical emitter and the optical interface element when the biological process fluid in the chamber is being analysed.

The wavelength discrimination component will typically be an optical filter, but could also be a component used to selectively direct light of a certain frequency towards the optical detector, such as a prism or a grating. As such, any element or collection of elements configured to select wavelengths of interest would be suitable, as would any element or collection of elements configured to direct wavelengths of interest towards the optical detector.

Likewise, references to wavelength discrimination components throughout the specification should be taken to encompass optical filters, prisms, gratings, and any other such element or collection of elements that allows for wavelengths to be discriminated.

In order to allow for the use of a broad-band optical emitter, also known as a broad-band source, the wavenumber range transmitted by the wavelength discrimination component may be tuneable and may, for example, be a tuneable filter. One example of a suitable tuneable filter is a MEMS Fabry-Perot tuneable filter. Another example of a tuneable filter can make use of a diffraction grating.

Current systems used to measure the absorption spectra of biological process fluids are expensive as they require the use of a tuneable optical emitter, typically a tuneable laser. In contrast, by providing a tuneable wavelength discrimination component a low cost broad-band source can be used as the optical emitter.

Another benefit of embodiments in which a tuneable wavelength discrimination component is used is that tuneable wavelength discrimination components, especially MEMS Fabry-Perot tuneable filters, are typically small. Likewise, broad-band sources are also typically small. This means that the system can be made smaller than systems that use tuneable lasers, which are usually large and bulky.

The system may also comprise one or more further wavelength discrimination components. These may be tuneable wavelength discrimination components, but some embodiments of the first aspect of the invention make use of multiple fixed bandwidth wavelength discrimination components in place of one or more tuneable wavelength discrimination components. These embodiments provide the same advantages as though in which a tuneable wavelength discrimination component is used, but using multiple fixed bandwidth wavelength discrimination components rather than tuneable wavelength discrimination components allows for reductions in cost and also improves reliability by reducing the number of moving parts in the system. Another advantage is that fixed bandwidth wavelength discrimination components typically perform better in their range of use, which is to say they have better rates of transmission and have smaller bandwidths. For example, fixed bandwidth spectral filters have better rates of transmission and have smaller bandwidths than tuneable filters.

In embodiments in which one or more tuneable wavelength discrimination components are provided, the processor may be configured to control the wavenumber range transmitted (or directed towards the optical detector) by said one or more wavelength discrimination components.

According to a second aspect of the invention, an optical analysis device for analysing a biological process fluid in a biological process vessel is provided, the optical device comprising: an optical emitter configured to emit light in the mid-infrared range; an optical detector configured to detect light in the mid-infrared range; a wavelength discrimination component; an alignment component for aligning the optical emitter, optical detector, and wavelength discrimination component with an optical interface element of the biological process vessel; and a processor configured to: receive outputs from the optical detector; and process the received outputs from the optical detector to provide an indication of the constituents of the biological process fluid being analysed.

According to a third aspect of the invention, a biological process vessel is provided for use in a system according to the first aspect of the invention, the vessel comprising a chamber and an optical interface element for optically coupling the chamber to an external optical emitter, external wavelength discrimination component, and external optical detector when a biological process fluid in the chamber is being analysed, the optical interface element being configured to couple light in the mid-infrared range.

By integrating an optical interface element directly into the biological process vessel, it is possible to take absorption spectrum measurements of a biological process fluid in the chamber without taking samples or making use of additives, and thereby to monitor the biological process.

### BRIEF DESCRIPTION OF THE FIGURES

The invention will be described with reference to the figures, in which:

FIGS. 1a and 1b show a system used to make infrared absorption measurements in transmission;

FIG. 2 shows an illustrative diagram of the principle behind using attenuated total reflection to make infrared absorption measurements;

FIG. 3 shows a system according to embodiments of the invention;

FIG. 4 shows the coupling between an attenuated total reflection element and emitter-receiver hardware according to embodiments of the invention;

FIG. 5 shows another example of the coupling between an attenuated total reflection element and emitter-receiver hardware according to embodiments of the invention;

FIG. 6 shows an arrangement of an attenuated total reflection element and emitter-receiver hardware according to embodiments of the invention;

FIG. 7 shows another arrangement of an attenuated total reflection element and emitter-receiver hardware according to embodiments of the invention;

FIGS. 8 to 16 show examples of attenuated total reflection elements that may be used in embodiments of the invention;

FIG. 17 shows the coupling between a transmission element and emitter-receiver hardware according to embodiments of the invention;

FIGS. 18 and 19 show examples of transmission elements that may be used in embodiments of the invention;

FIG. 20 shows another system according to embodiments of the invention in which an optical element is incorporated into a bypass loop;

FIG. 21 shows a system according to embodiments of the invention in which an optical element is incorporated into a waste outlet;

FIG. 22 shows a system according to embodiments of the invention in which the biological process vessel takes the form of a well plate; and

FIG. 23 shows a schematic example of a controller for use in emitter-receiver hardware in embodiments of the invention.

### DETAILED DESCRIPTION

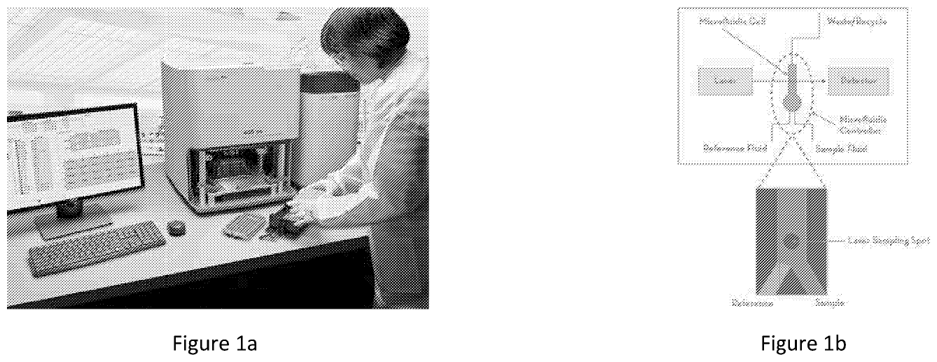

As has been described above, current solutions to monitor biological processes involve taking infrared absorption measurements in transmission, with one example of a system that may be used for this being the AQS3 from RedShiftBio. This system is shown in FIG. 1a, where it can be seen that human intervention is required to take these measurements and that these measurements are taken off-line. This poses the problem that a biological process fluid may become contaminated when samples are taken for analysis.

Another problem posed by this system lies in the way the measurements are taken, with FIG. 1b giving an illustration of the measurement process. A tuneable laser is directed through a microfluidic cell at a laser sampling spot towards a detector, thereby allowing the absorption spectrum in a narrow wavenumber range to be determined for a fluid flowing through the microfluidic cell. Upstream of the laser sampling spot the microfluidic cell diverges into two channels. One channel allows a reference fluid to be directed past the laser sampling spot to allow for the device to be calibrated while the other channel allows for a sample fluid to be introduced into the microfluidic cell.

The channels in the microfluidic cell must typically be less than 10 μm in width as the mid-infrared radiation used to take the absorption measurements cannot penetrate aqueous solutions beyond this distance. However, this could lead to frequent blockages in the microfluidic channel when the system is used to monitor biological processes containing larger particles, especially when the monitoring is on-line. As an example, cells are typically around 10 μm in size, and therefore pose a significant risk of blockages, as do partial cells. In contrast proteins are typically less than 1 μm in size.

Another problem faced with systems such as that shown in FIGS. 1a and 1b is that tuneable lasers are expensive and often bulky, making them less suitable for use in taking on-line measurements of biological process fluids.

For these reasons, another method of analysing biological process fluids is required.

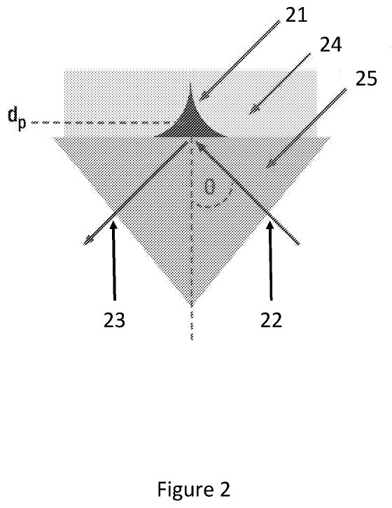

One approach to this problem is to use attenuated total reflection (ATR) to measure the absorption spectrum of a sample, thereby obviating the need to take measurements in transmission. The principle behind this process is illustrated in FIG. 2, which shows how an evanescent wave 21 is created when an incoming infrared beam 22 is reflected 23 at the interface between a sample 24 and a crystal 25. The evanescent wave 21 typically penetrates to depth dₚ of between around 0.5 μm and around 2 μm into the sample 24, and the interactions between the analytes in the sample 24 and the evanescent wave 21 will alter the intensity of the reflected infrared beam 23. By comparing the intensity of reflected light 23 with the intensity of incident light 22, it is therefore possible to determine the absorption spectrum of the analytes in the sample 24, and thereby to determine the constituents of that sample 24.

Current uses of ATR to analyse samples involve the use of Fourier Transform Infrared (FTIR) analysis, a process in which the wavenumber of an incoming broadband infrared beam is rapidly swept through a range of values using an interferometer. Fourier analysis is then used to infer the infrared absorption spectrum of the sample from measurements in the reflected infrared beam. While this method can have its advantages, FTIR instruments are complicated and delicate to set up. As such, FTIR instruments are often not suitable for taking on-line measurements of biological processes. That being said, the embodiments of the invention described herein are not incompatible with FTIR analysis.

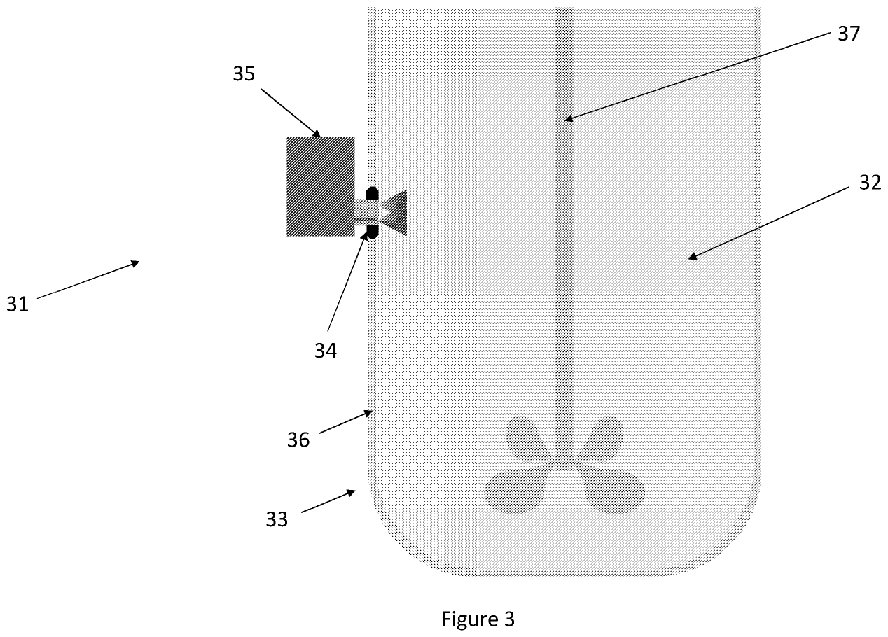

The system 31 shown in FIG. 3 addresses some of these drawbacks and allows for a biological process fluid 32, such as a biological culture or other biochemical product, to be analysed within the process vessel 33. For ease of reference, we refer mainly to a biological process fluid throughout the specification, but this should be taken as interchangeable with biological process. The term biological process should be taken to encompass bioprocesses, which are biological processes involving whole cells, and biological cultures, which are biological processes in which cells or viruses are grown, as well as their downstream products.

Examples of biochemical products that may be analysed using the system shown in FIG. 3 are: cell cultures and viral cultures; biological processes such as antibody production, virus production, and other biologic production; foodstuffs and beverages (for example when brewing); water; blood or plasma (for example in medical dialysis loops, for blood glucose measurement, such as in surgery, or for other analyte measurement in-vivo); urine; and other bodily fluids.

Biological process vessel 33 could also form an integral part of a bioreactor and therefore include a number of other features. For example, a stirrer 37 is shown as part of biological process vessel 33, which is optional and may not be present in all embodiments. Although not shown, the biological process vessel may also comprise a breather that includes a sterile filter, for example a filter with a pore size of 0.22 μm. In these cases, the biological process vessel is referred to as a closed biological process vessel. Although the presence of the filter means that the chamber is not fully sealed, the pore size is sufficiently small that microbes and other contaminants cannot enter the chamber. As only air is able to enter the chamber, the chamber is therefore sterile.

The biological process vessel 33 of system 31 can be integrated into a variety of bioreactors, such as a rigid vessel bioreactor (including a stirred tank); a flexible bag bioreactor; a fixed-bed bioreactor; as part of a recirculation loop; and as part of a perfusion input/output. The biological process vessel 33 could also be integrated into cell culture lab consumables such as cell culture flasks or could take the form of a well-plate.

In addition to the process vessel 33, the system 31 comprises an optical interface element 34 and emitter-receiver hardware 35. The optical interface element 34 forms an integral part of the wall 36 of process vessel 33 and is in direct contact with the biological process fluid 32 inside the process vessel 33. Optical interface element 34 is preferably biocompatible, which is to say that it does not affect the growth or health of cells or other biological particles within the biological process fluid 32, and does not otherwise affect the biological process. However, this is not essential in all use cases, such as perfusion output. Optical interface element 34 may also include a coating, such as a diamond coating or diamond-like coating. The emitter-receiver hardware 35 can be reversibly coupled with the optical interface element 34 to enable measurements of the absorption spectrum of the biological process fluid 32. Typically, the measurements will be focused on a portion of the mid-infrared spectrum (the fingerprint region) chosen to allow for the concentration of analytes in the biological process fluid 32 (such as glucose, lactate, or amino acids) to be monitored.

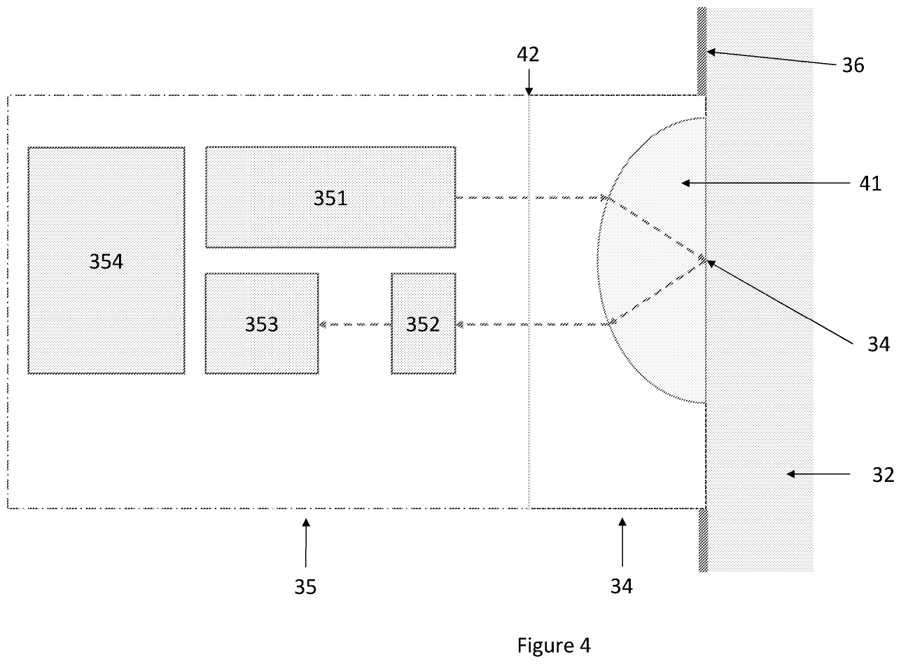

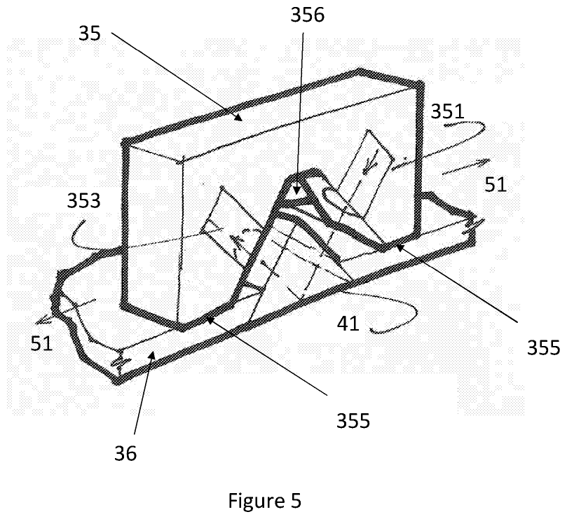

The emitter-receiver hardware 35 itself comprises a broad-band source of infrared radiation 351, a tuneable filter 352, a broad-band detector 353, and a processor 354. The elements of the emitter-receiver hardware are only shown schematically in the figures. Although the embodiments shown in the figures are described with reference to emitter-receiver hardware 35 comprising a tuneable filter 352, the embodiments are also compatible with other wavelength discrimination components. The figures also indicate the optical path of the radiation generated by source 351 in various embodiments of the invention. In some cases this is shown using arrows, with the arrows indicating the direction of the radiation. Although FIGS. 4, 12, and 17 show that the source 351 and detector 353 arranged such that the optical paths of the emitted and received radiation are parallel, the elements of the emitter-receiver hardware 35 can be arranged differently, such as is shown in FIGS. 5 to 7, 21, and 22.

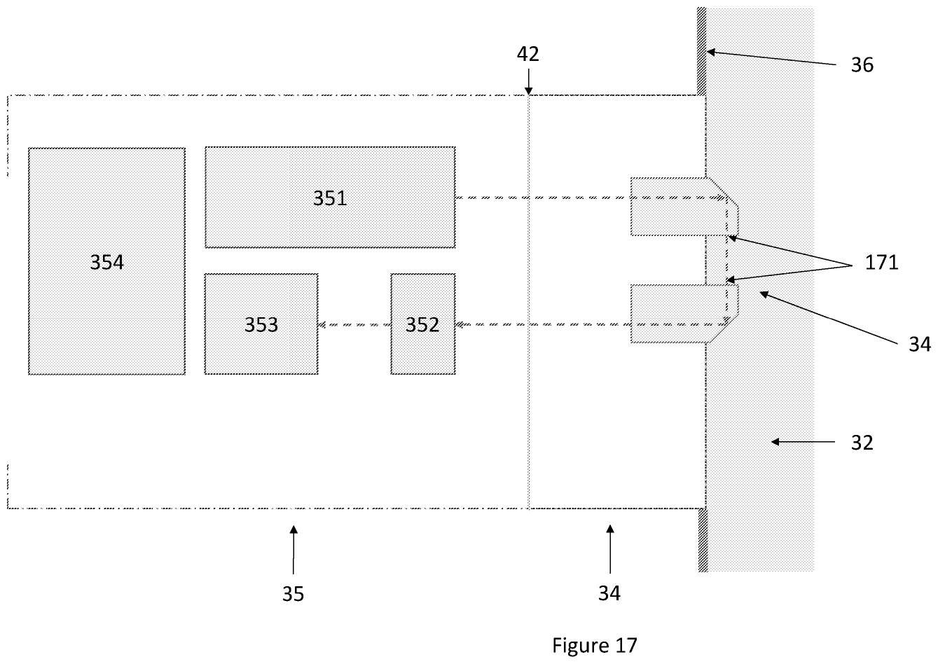

As illustrated in FIGS. 4 and 17, the broad-band source 351 is used to generate infrared radiation which is then directed through the optical interface element 34. The radiation received from the optical interface element 34 is then filtered by the tuneable filter 352 and its intensity measured by the broad-band detector 353. In some alternative embodiments, the tuneable filter 352 is positioned between the broad-band source 351 and the optical interface element 34 rather than between the broad-band detector 353 and the optical interface element 34.

The emission spectrum of the broad-band source 351 is known, and it is therefore possible to determine the absorption spectrum of the biological process fluid 32 in the biological process vessel 33 by measuring the intensity of light absorbed by the broad-band detector 353. The tuneable filter 352 is swept through a range of wavenumbers and the intensity of light transmitted to the broad-band detector 353 is measured for each of those wavenumbers. The measured intensities are then compared with the known emission spectrum of the broad-band source 351 to determine the absorption spectrum of the biological process fluid 32. The determined absorption spectrum is then processed to determine the concentration of a known analyte or analytes (e.g. glucose, lactate, or amino acids) within the biological process fluid 32. The absorption spectrum is a measure of relative absorption of radiation of different wavenumbers. This means that the measurement of the absorption spectrum is not affected by losses in the system as a whole, since the magnitude of these losses is not dependent on wavenumber.

This differs from the approach taken previously in which it is the infrared radiation source that is tuneable to allow for the absorption to be determined at different wavenumbers, and has the benefit that it does not require the use of costly, and often bulky, tuneable lasers. However, the use of a tuneable radiation source is not incompatible with the system of FIG. 3 and could therefore be used in place of a broad-band radiation source 351 and tuneable filter 352.

In order to ensure the analytes of interest can be identified, the broad-band source 351 emits radiation at least across the wavenumber range of 900 cm⁻¹ to 1500 cm⁻¹, which is the portion of the fingerprint region that is of most interest. However, in many embodiments the broad-band source emits radiation across the full fingerprint region of wavenumbers in the range of 500 cm⁻¹ to 1500 cm⁻¹. In some embodiments, the broad-band source 351 will emit radiation across a wider portion of the mid-infrared spectrum, such as wavenumbers of 500 cm⁻¹ to 4000 cm⁻¹. Likewise, the broad-band detector 353 is chosen such that it can detect wavenumbers at least across the range of 900 cm⁻¹ to 1500 cm⁻¹, preferably across the range of 500 cm⁻¹ to 1500 cm⁻¹, and most preferably across the range of around 500 cm⁻¹ to around 4000 cm⁻¹, with the tuneable filter 352 selected such that it can sweep across a significant portion of these wavenumbers. In some embodiments a tuneable filter is used that can be swept across the range of 950 cm⁻¹ to 1250 cm⁻¹, which may be combined with a second tuneable filter that can be swept across the range of 1250 cm⁻¹ to 1500 cm⁻¹.

In some embodiments, the broad-band detector 353 is a pyroelectric detector. However, a photovoltaic detector, such as an InAsSb detector, or a superlattice detector, such as an InAs/GaSb detector, could also be used.

In order to improve the registration between the emitter-receiver hardware 35 and the optical interface element 34, a coupling system 42, also referred to as an alignment component, may be used to constrain or otherwise guide their relative movement.

The coupling system may comprise engagement elements, which include corresponding elements on the emitter-receiver hardware 35 and optical interface element 34 and may, for example, take the form of a bayonet fitting or of a magnetic attachment. The engagement elements can also include, for example, one or more guide pins provided on either the emitter-receiver hardware 35 or the optical interface element 34, which are received by a corresponding one or more holes on the other of the emitter-receiver hardware 35 or the optical interface element 34. The coupling system 42 may also enable dynamic positioning of the emitter-receiver hardware 35 with respect to the optical interface element 34, which is to say that it may comprise a spring element that biases the emitter-receiver hardware 35 into correct alignment with the optical interface element 34. The dynamic positioning may also be achieved through use of a magnet.

By making use of emitter-receiver hardware 35 that can be detached from an optical interface element 34 integral to the process vessel 33, the system 31 of FIG. 3 enables the use of a single-use process vessel 33. This is particularly advantageous as the emitter-receiver hardware 35 will typically be the most expensive part of system 31.

In a system in which the emitter-receiver hardware is integral to the biological process vessel it is necessary either to design the biological process vessel to be reusable, which is typically undesirable and impractical, or to dispose of the emitter-receiver hardware along with the biological process vessel. This is costly and wasteful, and in most cases would also mean using cheaper emitter-receiver hardware, which would lead to a lower quality of measurements being made of the biological process fluid being analysed. By enabling the use of a single-use process vessel 33 that can be detached from reusable emitter-receiver hardware 35, these problems are overcome.

As indicated above, more than one tuneable filter can be used, each covering different spectral ranges. These ranges may overlap. Another possibility is the use of one or more fixed-bandwidth spectral filters, which in some embodiments can be combined with one or more tuneable filters. In this latter case, the multiple fixed-bandwidth spectral filters allow the tuneable filters to be calibrated by providing a reference to make sure the tuneable filters are operating in the correct portion of the spectrum or to ensure that its transmission properties have not degraded. In still further embodiments, grating-based spectral discrimination, in which radiation is reflected in different directions depending on its wavenumber, is used in place of a filter.

Multiple filters can be implemented by use of a beam splitter to direct light towards different filters, or through the use of a system that moves individual filters across the path of the radiation.

FIG. 4 shows the optical interface element 34 in more detail for embodiments in which the optical interface element 34 comprises an ATR element 41. The method of operation of the system 31 according to these embodiments is the same as described above, with the absorption spectrum measurements making use of the ATR mechanism described in relation to FIG. 2. In some embodiments the geometry of the ATR element 41 is configured to improve the optical coupling efficiency with the emitter-receiver hardware 35 over an extended range of positions of the emitter-receiver hardware relative 35 to the ATR element 41, as will be described below.

FIG. 5 shows an example of the coupling between an attenuated total reflection element 41 and emitter-receiver hardware 35 according to embodiments of the invention. In this embodiment the attenuated total reflection element 41 takes the form of a prism having a triangular cross-section, which may be an equilateral triangular cross-section. The operation of a system which makes use of such an attenuated total reflection element 41 is insensitive to translation along the wall 36 of the biological process vessel of the emitter-receiver hardware 35 relative to the attenuated total reflection element 41 (indicated by arrows 51 in FIG. 5), which is to say that measurements taken by detector 353 are independent of the relative positions of the emitter-receiver hardware 35 and the attenuated total reflection element 41 within a plane tangent to the interface between triangular prism ATR element 41 and biological process fluid 32.

In this embodiment, the alignment component 42 comprises a recess 356 in emitter-receiver hardware 35 having a cross-section configured to receive prism 41, thereby aiding the alignment of the emitter-receiver hardware 35 with prism 41. The cross-section of recess 356 is preferably larger than the cross-section of prism 41 so as to give a tolerance in the positioning of the emitter-receiver hardware 35.

In this embodiment, the emitter-receiver hardware 35 is configured such that the source 351 emits radiation in a direction substantially perpendicular to a surface of the prism 41 on which the radiation is incident. Furthermore, the emitter-receiver hardware 35 is configured such that the detector 353 receives radiation which has been internally reflected in the prism 41 and which is perpendicular to the surface of the prism 41 through which the radiation exits the prism 41.

The alignment component 42 may also comprise one or more additional couplings (also referred to as engagement elements) between the faces 355 of the emitter-receiver hardware 35 and the wall 36 of biological process vessel 33. The one or more additional couplings may be, for example, a mechanical attachment (such as a bayonet fitting) or a magnetic attachment. Such additional couplings further aid alignment of the emitter-receiver hardware 35 with the prism 41.

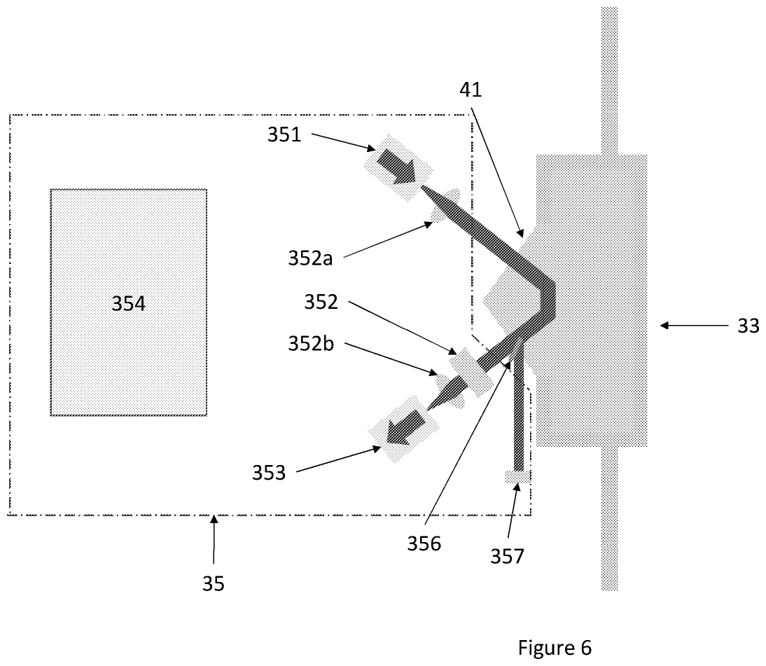

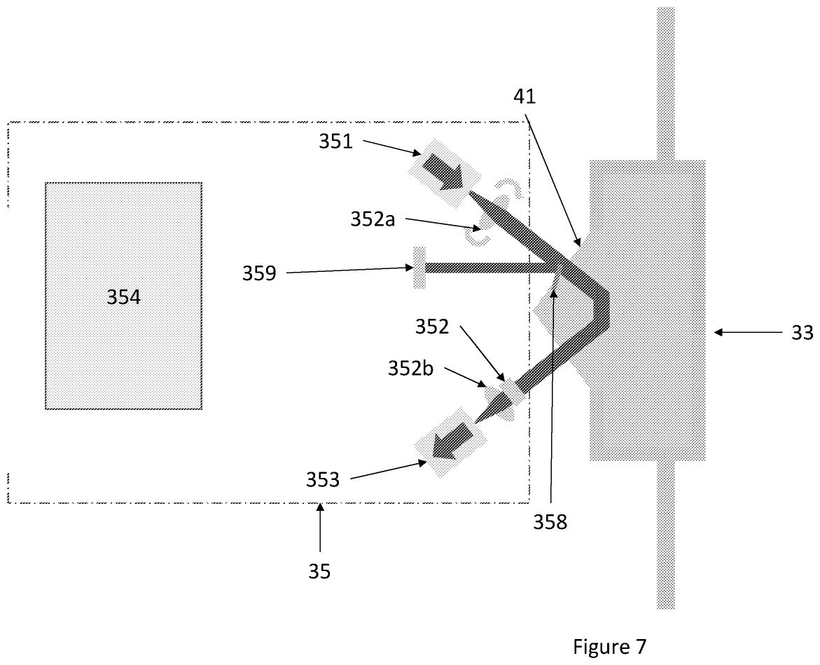

In the embodiments discussed above, emitter-receiver hardware 35 has been described which comprises an emitter 351 (also referred to as a source) and a detector 353. It may, however, be beneficial to include one or more further detectors as will now be described with reference to FIGS. 6 and 7.

FIG. 6 shows an arrangement of an attenuated total reflection element 41 and emitter-receiver hardware 35 in which light incident from detector 351 passes through optical element 352a (which typically comprises focussing optics) and is incident on ATR element 41, which may take the form of a prism as shown or may take other forms. The light is then reflected within ATR element 41 and passes through filter 352 and optical element 352b (which typically comprises focussing optics) before being received by detector 353.

In this arrangement, however, a beam splitting element 356, such as a beamsplitter or a pick-off mirror, is provided which directs a portion of the beam reflected within ATR element 41 towards a reference detector 357. The beam splitting element 356 may take any of various forms known in the art and may be integral to ATR element 41, as shown in FIG. 6, or may form part of emitter-receiver hardware 35. In both cases, the beam splitting element 356 is configured to be sensitive to changes in alignment between emitter-receiver hardware 35 and ATR element 41 such that the signal detected by reference detector 357 is sensitive to the relative position and/or the relative orientation between emitter-receiver hardware 35 and ATR element 41. This in turn allows for the signal detected by detector 353 to be compensated to account for changes due to the alignment of emitter-receiver hardware 35. This arrangement also allows for changes in the emission spectrum of emitter 351 to be compensated for, either through software or by movement and/or rotation of one or both of optical elements 352a and 352b.

In another arrangement, shown in FIG. 7, light incident from detector 351 again passes through optical element 352a and is incident on ATR element 41, which may take the form of a prism as shown or may take other forms. The light is then reflected within ATR element 41 and passes through optical element 352b and filter 352 before being received by detector 353.

In this arrangement, rather than including a beam splitting element 356 and a reference detector 357 between ATR element 41 and detector 353, a beam splitting element 358, such as a beamsplitter or a pick-of mirror, is included between ATR element 41 and emitter 351, either integrally to ATR element 41 or as part of emitter-receiver hardware 35. Beam splitting element 358 then directs a portion of the beam incident from emitter 351 towards a quadrant detector 359 which allows for the alignment of the emitter receiver-hardware 35 and ATR element 41 to be determined. (In some embodiments, other forms of detector, such a CMOS or a CCD camera, could be used in place of quadrant detector 359.) An operator may then manually adjust this alignment or, more preferably, the emitter-receiver hardware 35 includes active elements allowing for the misalignment to be corrected or compensated for. For example, one or both of optical elements 352a and 352b may be individually moveable and/or rotatable, as shown in FIG. 7. Alternatively, one or both of emitter 351 and detector 353 may be moveable or rotatable, or misalignment between ATR element 41 and emitter-receiver hardware 35 may be compensated through software.

The arrangements shown in FIGS. 6 and 7 therefore reduce the reliance on mechanical alignment of ATR element 41 and emitter-receiver hardware 35. As will be appreciated, further arrangements may be possible, including those in which both a reference detector 357 and a quadrant detector 359 are used to reduce the impact of misalignment between ATR element 41 and emitter-receiver hardware 35. Furthermore, although the operation of the hardware shown in FIGS. 6 and 7 has been described with reference to ATR element 41, the same principles could be applied to other forms of optical interface element 34, such as are shown in FIGS. 17 to 19.

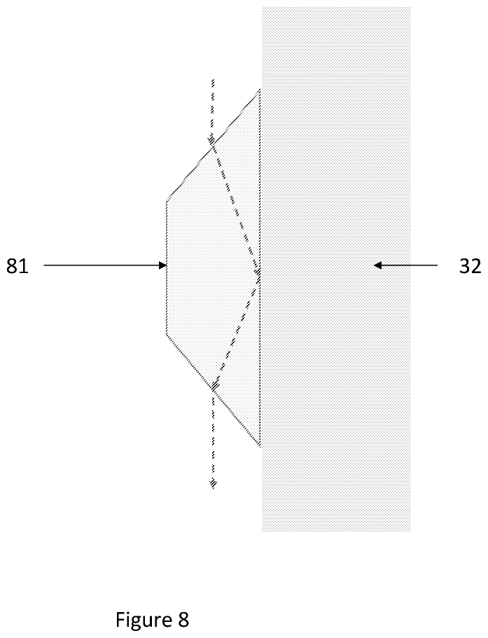

A variety of ATR elements will now be described with reference to FIGS. 8 to 16. Each of these figures illustrates the optical paths followed by incident light, but it should be noted that these optical paths are purely illustrative. Likewise, these figures do not show exact dimensions and geometry of the ATR elements.

FIG. 8 shows an example of a simple ATR element 81, which takes the form of a prism. Incident radiation is directed along a direction substantially parallel to the interface between the ATR element 81 and the biological process fluid 32 being measured and is refracted towards that interface when it meets a first surface of the ATR element 81. The radiation is then reflected at the interface between the ATR element 81 and the biological process fluid 32 towards a second surface of the ATR element 81 opposite to the first surface.

While the simple ATR element 81 is compatible with the system of FIGS. 3 to 7, it can be difficult in some cases for an operator to ensure that the emitter-receiver hardware 35 is correctly aligned with the ATR element 81. Since misalignment results in losses that affect the measurements taken at the detector 353, a number of improved ATR elements have been developed.

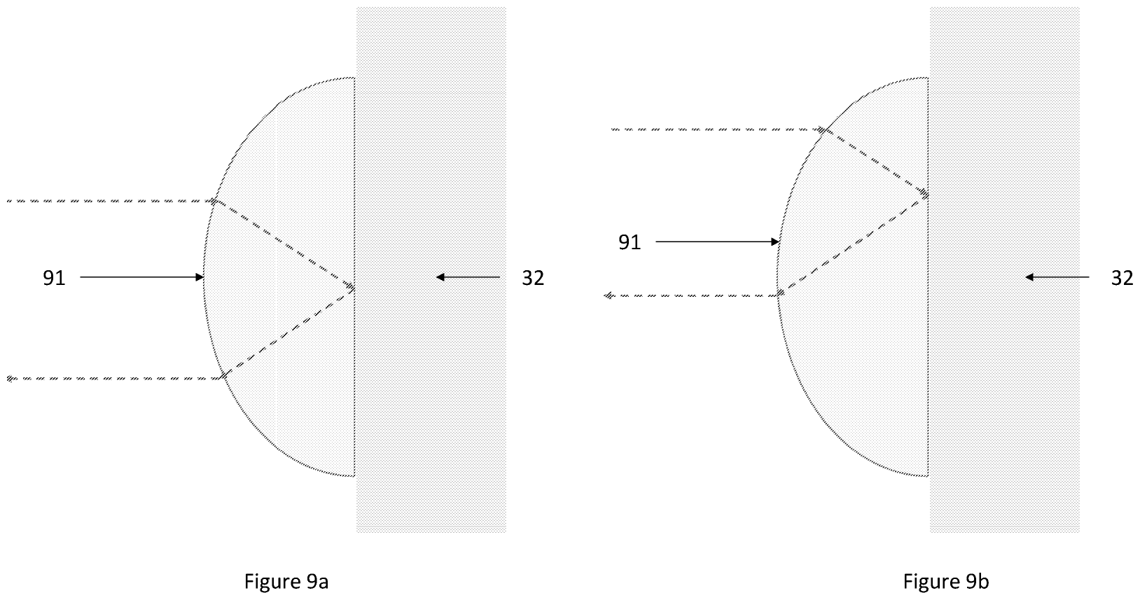

A first improved ATR element is shown in FIG. 9a that takes the form of a lens 91. Incident radiation is directed along a direction substantially perpendicular to the interface between the ATR element 91 and the biological process fluid 32 being measured, and this radiation is then refracted at the surface of the ATR element 91 towards the interface between the ATR element 91 and the biological process fluid 32 being measured. The light reflected from this interface is then refracted once more at the surface of the ATR element 91 such that it is once more directed along a direction substantially perpendicular to the interface between the ATR element 91 and the biological process fluid 32 being measured.

The benefit of this geometry is that the emitter-receiver hardware 35 can be translated along a direction parallel to the interface between the ATR element 91 and the biological process fluid 32 without a significant loss in optical coupling efficiency. FIG. 9b illustrates the optical path of the radiation when the emitter-receiver hardware 35 is translated from its position in FIG. 9b. As can be seen, the incident radiation is still substantially parallel to the outgoing radiation, which means that detector 353 is still able to accurately measure the intensity of the radiation reflected from the interface between the ATR element 91 and the biological process fluid 32.

Another benefit of lens 91 is that it is typically rotationally symmetrical about its central axis (the axis perpendicular to the interface between lens 91 and biological process fluid 32), which means that measurements taken using emitter-receiver hardware 35 are insensitive to rotation of the emitter-receiver hardware 35 relative to the attenuated total reflection element 41, which is to say that measurements taken by detector 353 are independent of the relative orientation of the emitter-receiver hardware 35 and the attenuated total reflection element 41.

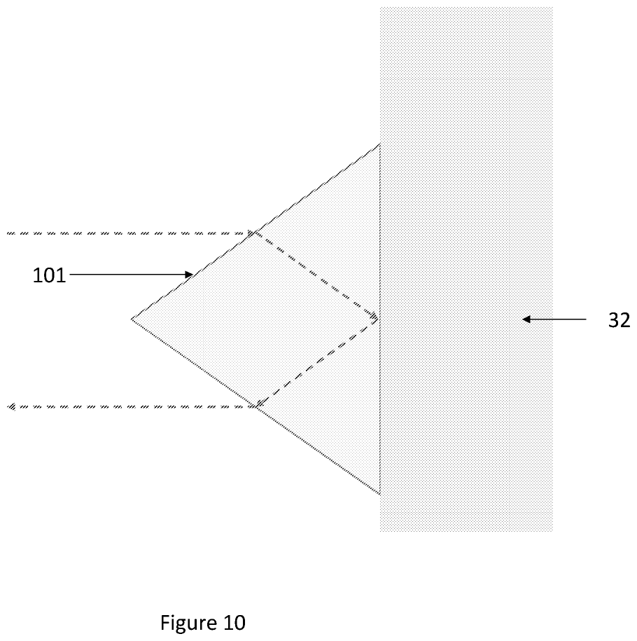

Another beneficial geometry is shown in FIG. 10. The triangular shaped element 101 has sides that are more steeply angled with respect to the surface in contact with biological process fluid 32 than with the simple ATR element 81 shown in FIG. 8, which allows for a larger range of positions of the emitter-receiver hardware 35.

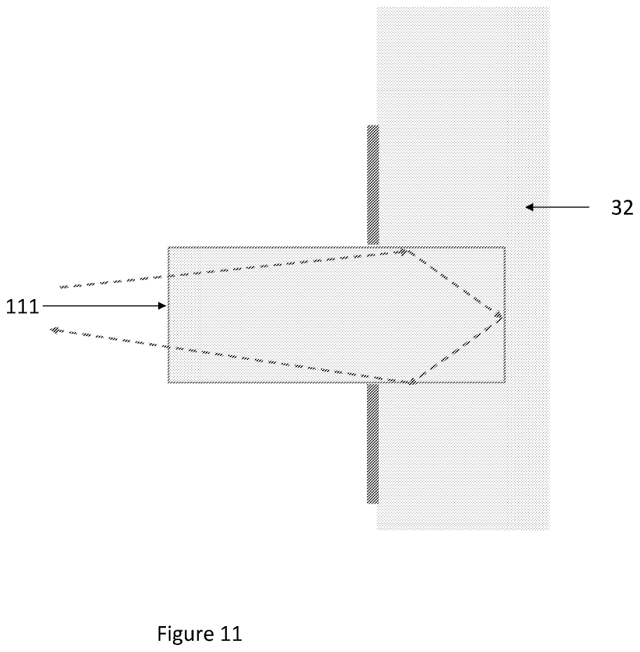

Another example of an improved ATR element is shown in FIG. 11 and takes the form of a rod 111 that extends into the biological process fluid 32 being measured. This ATR element 111 increases the number of surfaces at which an evanescent wave can be created and therefore improves the accuracy of the absorption spectrum measurements. The optical coupling efficiency with the emitter-receiver hardware 35 is also less sensitive to translation than the simple ATR element 81 of FIG. 8.

A further benefit to rod 111 is that it allows the element to monitor the biological process fluid 32 at deeper regions of the biological process vessel 33. As the biological process fluid 32 that is further from the edges of the biological process vessel 33 is less likely to become stagnant, this geometry may therefore allow for improved monitoring of the biological process fluid 32.

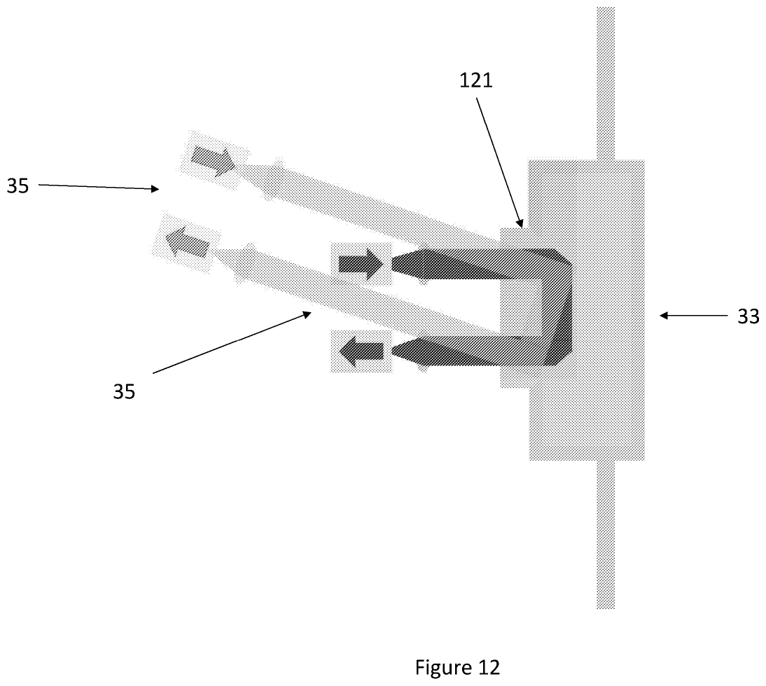

In some instances, it will be advantageous to provide a system which is insensitive to the angular alignment between emitter-receiver hardware 35 and ATR element 41, which is to say that measurements taken by detector 353 are independent of the angle of incidence of light from emitter 351. FIG. 12 illustrates such an example, in which ATR element 41 takes the form of a retroreflecting (or cat's eye) element 121. As illustrated by the two different positions of emitter-receiver hardware 35 shown in FIG. 12, the shape of this retroreflecting element is such that the light reflected within element 41 is antiparallel to the light incident from 351, ensuring that the reflected light is received by detector 353.

Another advantage of retroreflecting element 121 is that its outer surface is flat, which means that it is not necessary to incorporate a recess into emitter-receiver hardware 35, giving more options when designing alignment component 42.

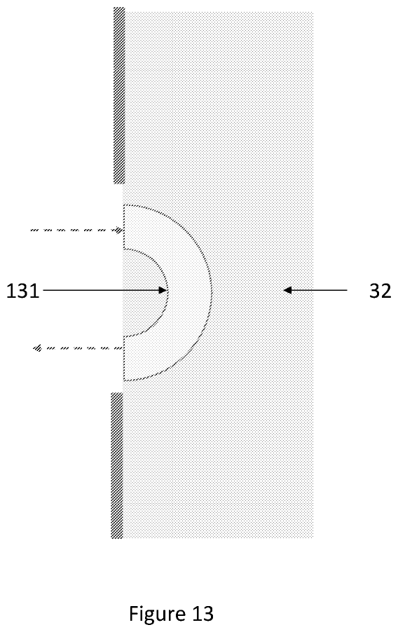

Another ATR element that aims at increasing the number of surfaces at which an evanescent wave can be created is shown in FIG. 13. An optical fibre 131 passes through the biological process fluid 32 in a loop such that each end of the optical fibre 131 is exposed to the outside of the biological process vessel. The diameter of the optical fibre 131 has been exaggerated for ease of illustration. Since, in practice, radiation passing through the optical fibre 131 will undergo many reflections owing to the smaller diameter of the optical fibre 131, the optical path within optical fibre 131 has not been illustrated.

As will be understood, the optical fibre 131 acts as a waveguide and radiation incident on one end of the optical fibre 131 will pass along the length of the optical fibre 131, exiting at the other end of the optical fibre 131. As the radiation passes along the optical fibre 131, evanescent waves are formed in the biological process fluid 32 across the surface and along the length of optical fibre 131. Consequently, this ATR element is particularly suitable for taking absorption spectrum measurements of a biological process fluid 32 in the process vessel 33. The cost of optical fibre 131 is also lower than other designs of ATR element 41.

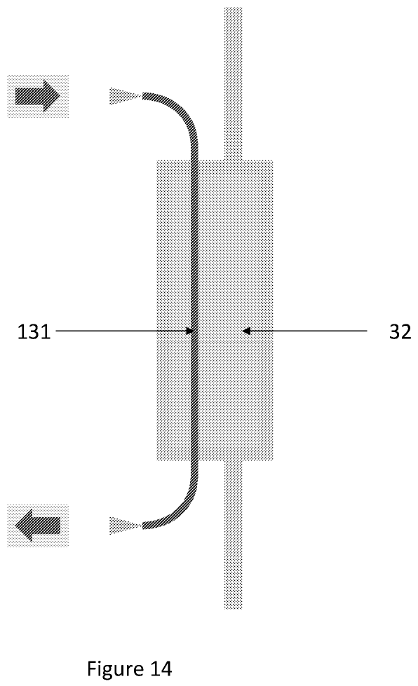

The optical fibre 131 is also especially suited to taking measurements of a biological process fluid 32 in a flow cell or flow path owing to the elongate shape of flow cells and flow paths, and such an embodiment is illustrated in FIG. 14. In this embodiment, the optical fibre 131 advantageously runs along the length of the flow cell or flow path, and may also be coiled to increase the optical path length.

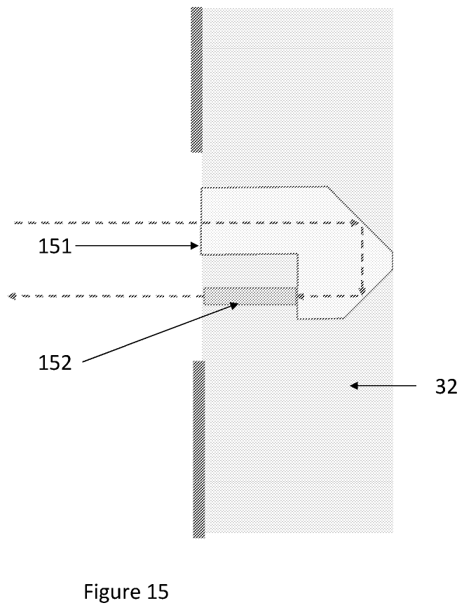

FIG. 15 shows an ATR element designed using the same principles as the elements shown in FIGS. 11 and 13. The use of an element 151 that protrudes into the biological process fluid 32 similar to rod 111 shown in FIG. 11, while the use of an optical fibre 152 allows for more reflections at the boundary with the biological process fluid 32, similar to optical fibre 131 shown in FIG. 13, both of which allow for improved monitoring of the biological process fluid 32. Element 151 also supports the optical fibre 152, thereby improving durability of the optical fibre 152. As with optical fibre 131, the optical path within optical fibre 152 has not been illustrated.

Both optical fibre 131 and optical fibre 152 can be graded-index, single-mode, or multi-mode fibres.

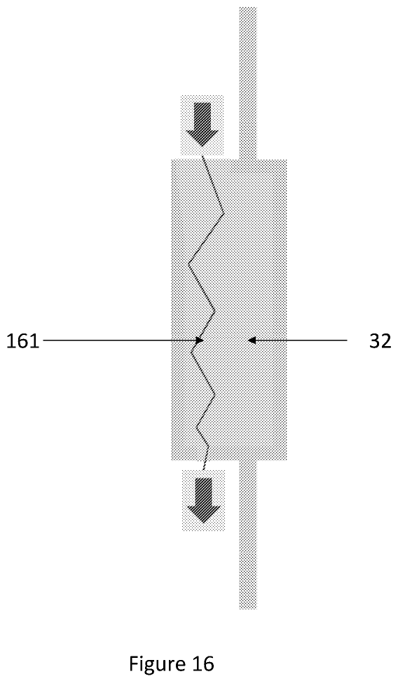

Other forms of waveguide than optical fibres could also be implemented, as is shown in FIG. 16. In this example, the ATR element 41 takes the form of a waveguide 161 having a funnel shape, with a wider diameter where light is to be received from emitter 351 and a narrower diameter where reflected light is to be output to detector 353. This design is especially suited to taking measurements of a biological process fluid 32 in a flow cell or flow path, although it is nevertheless suitable for taking measurements in other forms of biological processing vessel 33. For example, the waveguide 161 could take the form of a curved funnel so as to be suitable for provision in the wall 36 of a biological processing vessel 33, similar to the optical fibre of FIG. 13.

In each of the embodiments illustrated in FIGS. 13 to 16 the light within the ATR element 41 undergoes multiple reflections, thereby leading to more interactions between evanescent waves and biological process fluid 32. In other embodiments of the invention in which the light only undergoes a single reflection within the ATR element 41, the formation of an evanescent wave may be affected by changes in the relative orientation of emitter-receiver hardware 35 and ATR element 41, which would in turn lead to changes in the absorption of light by the biological process fluid 32. By increasing the number of reflections within the ATR element 41, these changes are averaged out in the embodiments shown in FIGS. 13 to 16 reducing the sensitivity of measurements made by detector 353 to the relative orientation of emitter-receiver hardware 35 and the ATR element 41. For this reason, in embodiments in which the ATR element 41 comprises an optical fibre 131 it may be advantageous to increase the optical path length, for example by coiling the optical fibre 131, so as to increase the surface area of optical fibre 131 and thereby the area across which evanescent waves will interact with biological process fluid 32.

While many embodiments of the invention are based on the use of an ATR element 41, the invention is also suitable for use with an optical interface element 34 suitable for taking absorption spectrum measurements in transmission.

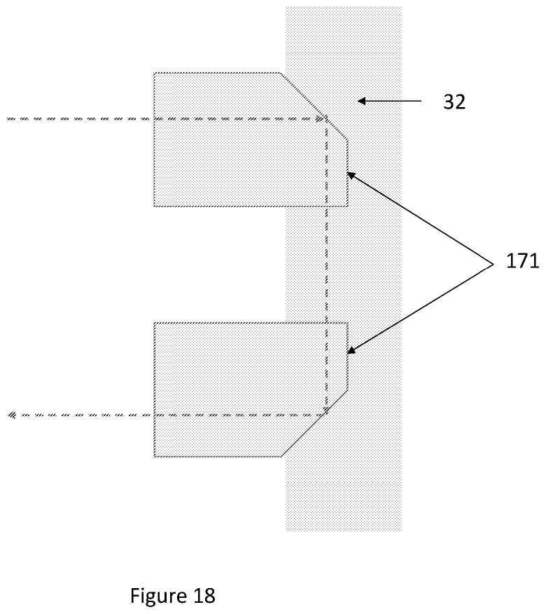

FIG. 17 shows the coupling between the emitter-receiver hardware 35 and the optical interface element 34 in more detail for embodiments in which the optical interface element 34 is configured to allow for transmission based absorption spectrum measurements. Typically, in these embodiments the optical interface element 34 will take the form of two optical windows 171, as is shown in FIG. 18, with the other elements of the system unchanged from the embodiments in which the optical interface element 34 is an ATR element.

As can be seen from FIG. 18, the two optical windows 171 are mirror images of one another (although in some embodiments they could be different), with incident light directed at an inclined surface of the first optical window 171 and reflected towards the second optical window 171 through the biological process fluid 32 being measured. The radiation is then reflected at the corresponding inclined surface of the second optical window 171 and towards the optical detector 353. The two inclined surfaces are typically mirrored to reduce losses in the system. The measurements made by the detector 353 can then be used to determine the absorption spectrum of the biological process fluid 32 being analysed. The distance between the two windows 171 is typically less than 10 μm to ensure the radiation can penetrate through the biological process fluid 32 to reach the second optical window 171.

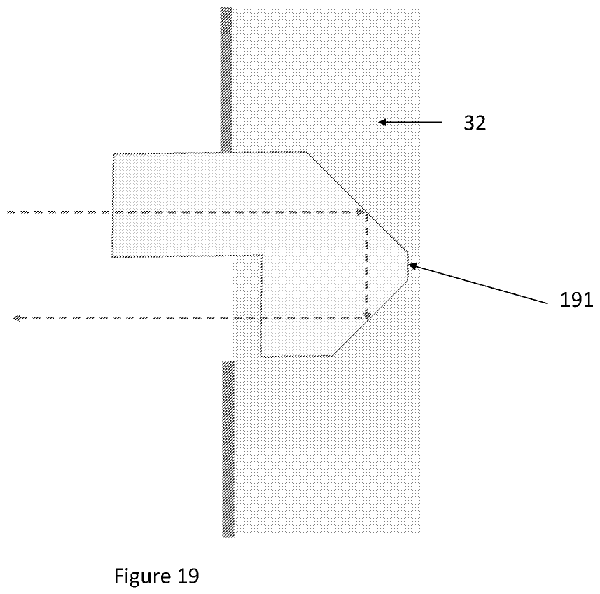

FIG. 19 illustrates an alternative optical interface element 34 that can be used to take absorption measurements in transmission. Rather than providing two optical windows and transmitting radiation between the two windows, a single element 191 is used. This element is shaped such that a narrow channel is formed between one half of element 191 and a portion of wall 36 of the process vessel that efficiently transmits infrared radiation. Transmission measurements can then be taken of the biological process fluid passing through this channel.

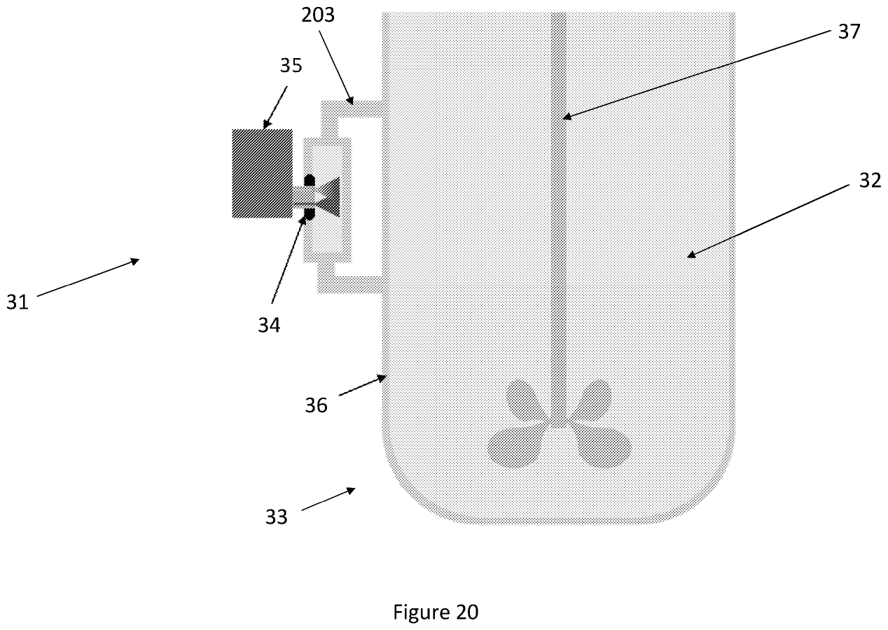

While the emitter receiver hardware and optical interface elements have been described with reference to measurements taken of a bulk biological process fluid in a closed biological process vessel, as shown in FIG. 3, they are equally compatible with measurements taken of a biological process fluid in a bypass loop 203, such as a flow cell or flow path, connected to biological process vessel 33 as shown in FIG. 20.

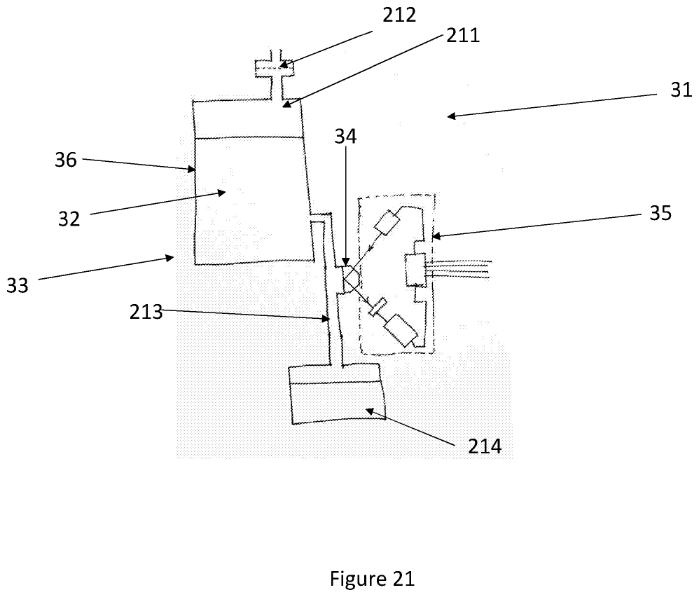

The optical interface elements described herein can also be incorporated into a waste line 213 as shown in FIG. 21. This allows a biological process to be monitored by determining the analytes in waste fluid 214 drained from biological process fluid 32. This embodiment is advantageously employed when the biological process vessel 33 takes the form of a bioreactor.

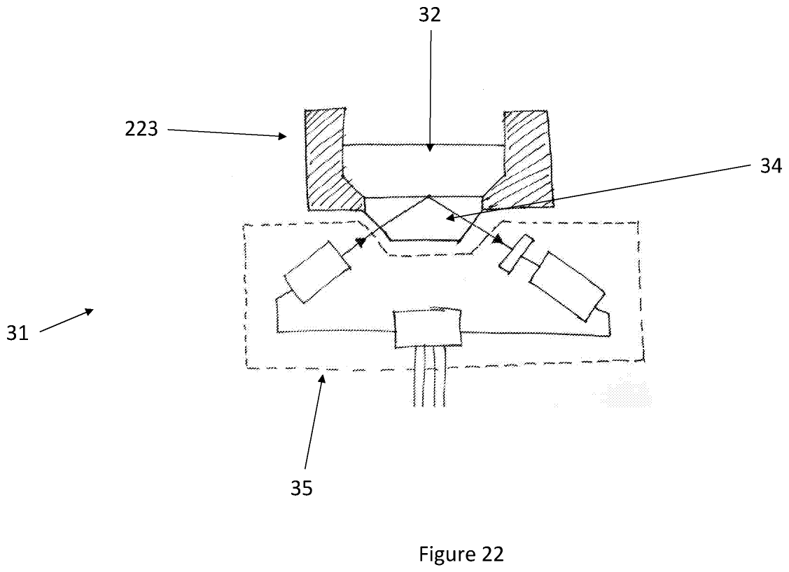

In many of the embodiments of the present invention, the biological process vessel 33 will take the form of a closed system in which the gases 211 in the biological process vessel 33 are regulated, possibly through the use of a breather 212 comprising a sterile filter (as shown in FIG. 21). However, the biological process vessel 33 may also take the form of a well plate 223 in which the top of the vessel is open, as shown in FIG. 22. In this case, the optical interface element will typically be positioned in the lower surface of the well plate 223.

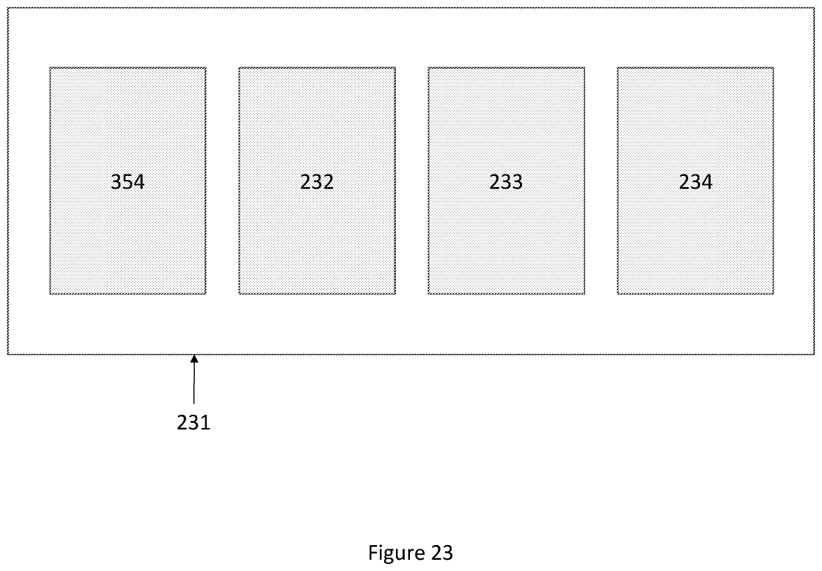

In some embodiments, the processor 354 may form part of a controller 231, as shown in FIG. 23. Controller 231 could form part of emitter-receiver hardware 35 and could additionally include one or more of a memory 232, control circuitry 233, and analysis circuitry 234, as well as any other elements advantageous to the operation of emitter-receiver hardware 35. Processor 354 is not limited to being a microprocessor and could, for example, be and electronic circuit comprising an op-amp, transistors, or other electronic components configured to process the analogue signals needed to receive signals from the optical detector.

Controller 231 could be configured to control any aspect of the functioning of emitter-receiver hardware 35, including operation of optical emitter 351, filter 352, optical elements 352a and 352b, optical receiver 353, and/or any other aspect of emitter-receiver hardware 35 such as tuneable optical elements, reference detectors, and/or quadrant detectors. In embodiments in which misalignment between optical interface element 34 may be compensated, either through hardware or software, this may also be controlled by controller 231. This control could be performed by processor 354 and/or by control circuitry 233. For example, processor 354 and/or control circuitry 233 could control optical elements 352a and/or 352b to compensate for misalignment of emitter-receiver hardware 35, for example based on measurements by reference detector 357 and or quadrant detector 359.

Controller 231 could also be configured to perform the analysis of the biological fluid. The analysis could be performed by processor 354 and/or by analysis circuitry 234.

1. An optical system for analysing biological processes comprising:
a biological process vessel comprising a chamber and an optical interface element for optically coupling the chamber to an optical emitter, a wavelength discrimination component, and an optical detector when a biological process fluid in the chamber is being analysed, the optical interface element being configured to couple light in the mid-infrared range;
an optical emitter configured to emit light in the mid-infrared range;
an optical detector configured to detect light in the mid-infrared range;
a wavelength discrimination component;
an alignment component for aligning the optical emitter, optical detector, and wavelength discrimination component with the optical interface element; and
a processor configured to: receive outputs from the optical detector; and process the received outputs from the optical detector to provide an indication of the constituents of a biological process fluid in the chamber.

2. (canceled)

3. A system according to claim 1, wherein the optical emitter is configured to emit infrared radiation in the wavenumber range of 500 cm⁻¹ to 4000 cm⁻¹, preferably in the range of 500 cm⁻¹ to 1500 cm⁻¹, and more preferably in the range of 900 cm⁻¹ to 1500 cm⁻¹.

4. A system according to claim 1, wherein the optical detector is configured to detect infrared radiation in the wavenumber range of 500 cm⁻¹ to 4000 cm⁻¹, preferably in the range of 500 cm⁻¹ to 1500 cm⁻¹, and more preferably in the range of 900 cm⁻¹ to 1500 cm⁻¹.

5. A system according to claim 1, wherein the wavelength discrimination component is positioned between the optical detector and the optical interface element when the biological process fluid in the chamber is being analysed.

6. A system according to claim 1, wherein the wavenumber range transmitted by the wavelength discrimination component is tuneable.

7. A system according to claim 1, wherein the system comprises one or more further wavelength discrimination components.

8. A system according to claim 7, wherein the wavenumber range transmitted by one or more of the one or more further wavelength discrimination components is tuneable.

9. A system according to claim 1, wherein the alignment component comprises an engagement component for engaging the optical emitter, optical detector, and wavelength discrimination component with the biological process vessel.

10. (canceled)

11. A system according to claim 1, wherein the chamber comprises one of a culture vessel, fluid well, flow cell, capillary tube, flow path, or bypass loop.

12. A system according to claim 1, wherein the optical interface element is in direct contact with a biological process fluid in the chamber when said biological process fluid is being analysed.

13. A system according to claim 12, wherein at least two faces of the surface of the optical interface element are in direct contact with said biological process fluid when said biological process fluid is being analysed.

14. A system according to claim 1, wherein the optical interface element is an attenuated total reflection optical interface element.

15. A system according to claim 14, wherein the attenuated total reflection optical interface element takes the form of a lens.

16. A system according to claim 14, wherein the attenuated total reflection optical interface element comprises an optical fibre.

17. A system according to claim 1, wherein the biological process vessel is reversibly removable from the system.

18. A system according to claim 1, wherein the biological process vessel comprises an engagement element for engaging the biological process vessel with the optical emitter, optical detector, and wavelength discrimination component.

19. An optical analysis device for analysing a biological process fluid in a biological process vessel comprising an optical interface element, the optical analysis device comprising:
an optical emitter configured to emit light in the mid-infrared range;
an optical detector configured to detect light in the mid-infrared range;
a wavelength discrimination component;
an alignment component for aligning the optical emitter, optical detector, and wavelength discrimination component with the optical interface element of the biological process vessel; and
a processor configured to: receive outputs from the optical detector; and process the received outputs from the optical detector to provide an indication of the constituents of the biological process fluid being analysed.

20. An optical analysis device according to claim 19, wherein the wavelength discrimination component is positioned between the optical detector and the optical interface element when the biological process fluid in the chamber is being analysed.

21. An optical analysis device according to claim 19, wherein the alignment component comprises an engagement component for engaging the optical emitter, optical detector, and wavelength discrimination component with a biological process vessel.

22. A biological process vessel for use in an optical system for analysing biological processes, the optical system comprising:
an optical emitter configured to emit light in the mid-infrared range;
an optical detector configured to detect light in the mid-infrared range;
a wavelength discrimination component;
an alignment component for aligning the optical emitter, optical detector, and wavelength discrimination component with the optical interface element; and
a processor configured to: receive outputs from the optical detector; and process the received outputs from the optical detector to provide an indication of the constituents of a biological process fluid in the chamber, the vessel comprising:
a chamber and an optical interface element for optically coupling the chamber to an external optical emitter, external wavelength discrimination component, and external optical detector when a biological process fluid in the chamber is being analysed, the optical interface element being configured to couple light in the mid-infrared range.
